(19) United States
(12) Patent Application Publication
(10) Pub. No.: US 2026/0171767 A1
(43) Pub. Date: Jun. 18, 2026

(54) Edge Prepped and/or Ceramic Coated Cutting Edge for a Wire Cutter of a Hand Tool

(71) Applicant: Milwaukee Electric Tool Corporation, Brookfield, WI (US)

(72) Inventors: Jack C. Melkovitz, Wauwatosa, WI (US); Matthew W. Roeber, Milwaukee, WI (US)

(21) Appl. No.: 19/433,239

(22) Filed: Dec. 26, 2025

Related U.S. Application Data
(63) Continuation of application No. PCT/US2025/059404, filed on Dec. 12, 2025.
(60) Provisional application No. 63/733,758, filed on Dec. 13, 2024.
(60) Provisional application No. 63/820,898, filed on Jun. 10, 2025.

(51) Int. Cl. H02G 1/12; H02G 1/00

(52) U.S. Cl. CPC H02G 1/1236; H02G 1/005

(57) ABSTRACT

Embodiments of the disclosure relate to a hand tool. The hand tool has a first jaw assembly with a first handle portion, a first jaw portion, and a first pivot portion. The first jaw portion has a first cutting edge. The hand tool further has a second jaw assembly with a second handle portion, a second jaw portion, and a second pivot portion. The second jaw portion has a second cutting edge. The first cutting edge and the second cutting edge are configured to operate as a wire cutter. Each of the first and second cutting edges include a first surface and a second surface in which the first and second surfaces are arranged at an angle in a range from 30° to 75°. Each of the cutting edges is rounded with a radius of curvature in a range of 0.02 mm to 0.09 mm.

### CROSS-REFERENCE TO RELATED APPLICATIONS

This application is a continuation of International Application No. PCT/US2025/059404, filed Dec. 12, 2025, which claims the benefit of and priority to U.S. Provisional Application No. 63/820,898, filed on Jun. 10, 2025, and to U.S. Provisional Application No. 63/733,758, filed on Dec. 13, 2024, which are incorporated herein by reference in their entireties.

### BACKGROUND OF THE INVENTION

The present disclosure is directed generally to hand tools including a wire cutter and, in particular, to wire cutters with specially configured cutting edges.

Wire cutters often include two members that are pivotally connected at a pivot point. A rear end portion of the wire cutter typically forms a handle of the wire cutter and a front end portion forms a head of the wire cutter. The handle is used to open or close jaws formed at the head that pivot about the pivot point, and the handles can be rotated to rotate the head. Therefore, the jaws can be used to cut a wire. In some circumstances, a wire cutter may include other tools on the tool head, including wire stripper apertures, pliers, bolt shears, etc.

### SUMMARY OF THE INVENTION

Various embodiments of the invention relate to a hand tool, such as a wire stripper. Wire strippers are used to remove an insulating jacket from a conductor core. Wire strippers often have additional tools to address problems commonly encountered by a user in conjunction with wire stripping. For example, a wire stripper may include bolt/screw shears to cut fasteners for electrical sockets or junction boxes to an appropriate size. Further, a wire stripper may include one or more holes for bending wire into pigtail loops. Additionally, a wire stripper may have a tapered tip with gripping surfaces to act as a needle-nosed plier. Still further, a wire stripper may include tapered surfaces configured to act as a wire cutter. According to embodiments of the present disclosure, embodiments of a hand tool, such as a wire stripper, are provided in which a jaw portion of the tool includes cutting edges configured to cut wires and in which the cutting edges are provided with a high resistivity ceramic coating and/or provided with a rounded edge.

In a first aspect, embodiments of the present disclosure relate to a hand tool. The hand tool comprises a first jaw assembly comprising a first handle portion, a first jaw portion, and a first pivot portion disposed between the first handle portion and the first jaw portion. The first jaw portion comprising a first cutting edge. The hand tool further comprises a second jaw assembly comprising a second handle portion, a second jaw portion, and a second pivot portion disposed between the second handle portion and the second jaw portion. The second jaw portion comprises a second cutting edge. The first cutting edge and the second cutting edge are configured to operate as a wire cutter. Each of the first cutting edge and the second cutting edge comprises a first surface and a second surface in which the first surface is arranged at an angle in a range from 30° to 75° with respect to the second surface. Each of the first cutting edge and the second cutting comprises a rounded edge connecting the first surface to the second surface in which a radius of curvature of the rounded edge is in a range of 0.02 mm to 0.09 mm.

In a second aspect, embodiments of the disclosure relate to the hand tool of the first aspect in which the second surfaces are in different planes such that the first cutting edge and the second cutting edge are in a bypass configuration.

In a third aspect, embodiments of the disclosure relate to the hand tool of the first aspect or the second aspect in which at least one of the first cutting edge or the second cutting edge comprises a ceramic coating having a resistivity of at least at least 1.0×10⁸ Ω·cm.

In a fourth aspect, embodiments of the disclosure relate to the hand tool of the third aspect in which the resistivity is in a range of 1.0×10⁸ Ω·cm to 1.0×10¹⁴ Ω·cm.

In a fifth aspect, embodiments of the disclosure relate to the hand tool of any of the first aspect to the fourth aspect in which the first jaw portion comprises a first plurality of aperture portions. The first cutting edge is disposed between the first plurality of aperture portions and the first pivot portion. The second jaw portion comprises a corresponding plurality of aperture portions. The second cutting edge is disposed between the corresponding plurality of aperture portions and the second pivot portion. The first plurality of aperture portions and the corresponding plurality of aperture portions, in a closed configuration of the hand tool, define wire stripper apertures having sizes configured to remove insulating jacket material from wires of a plurality of gauges.

In a sixth aspect, embodiments of the disclosure relate to the hand tool of any of the first aspect to the fifth aspect in which the first pivot portion comprises a first cutting recess having a first edge and the second pivot portion comprises a second cutting recess having a second edge. The first edge is defined between surfaces arranged at an angle in a range of 75° to 85°, and the second edge is defined between surfaces arranged at an angle in a range of 75° to 85°.

In a seventh aspect, embodiments of the disclosure relate to the hand tool of the sixth aspect in which at least one of the first edge or the second edge comprises a radius of curvature in a range of 0.02 to 0.09 mm.

In an eighth aspect, embodiments of the disclosure relate to the hand tool of any of the first aspect to the seventh aspect in which the first jaw portion and the first pivot portion are formed separately from the first handle portion and joined to the first handle portion using a fastener. The second jaw portion and the second pivot portion are formed separately from the second handle portion and joined to the second handle portion using a fastener. The first jaw portion and the second jaw portion each comprise a spring constant in a range from 450 N/mm to 550 N/mm.

In a ninth aspect, embodiments of the disclosure relate to the hand tool of the eighth aspect in which the first jaw portion and the second jaw portion each comprise an ultimate tensile strength in a range of 2100 MPa to 2500 MPa.

In a tenth aspect, embodiments of the disclosure relate to the hand tool of any of the first aspect to the ninth aspect in which the radius of curvature of the rounded edge is in a range of 0.03 mm to 0.08 mm.

In an eleventh aspect, embodiments of the disclosure relate to the hand tool of any of the first aspect to the tenth aspect in which the first cutting edge and the second cutting edge exhibit edge wear of 0.05 mm or less after 100 cutting cycles of the wire cutting.

In a twelfth aspect, embodiments of the disclosure relate to the hand tool of any of the first aspect to the eleventh aspect in which the first cutting edge and the second cutting edge exhibit edge wear of 0.1 mm or less after 5000 cutting cycles of the wire cutter.

In a thirteenth aspect, embodiments of the disclosure relate to the hand tool of any of the first aspect to the twelfth aspect in which a cutting torque required to actuate the wire cutter is 200 in·lb or less.

In a fourteenth aspect, embodiments of the disclosure relate to the hand tool of any of the first aspect to the thirteenth aspect in which, for each of the first cutting edge and the second cutting edge, the first surface is arranged at an angle in a range from 45° to 60° with respect to the second surface.

In a fifteenth aspect, embodiments of the disclosure relate to the hand tool according to any of the first aspect to the fourteenth aspect in which the rounded edge of each of the first cutting edge and of the second cutting edge comprises a depth of material removal in a range of 0.045 mm to 0.095 mm. The depth of material removal corresponds to a distance from a theoretical sharp edge to the rounded edge along a line bisecting the angle between the first surface and the second surface. The theoretical sharp edge corresponds to an intersection of a first plane extending from the first surface and a second plane extending from the second surface.

In a sixteenth aspect, embodiments of the disclosure relate to the hand tool of any of the first aspect to the fifteenth aspect in which the hand tool is one of a wire stripper, a lineman's pliers, or a diagonal pliers.

In a seventeenth aspect, embodiments of the present disclosure relate to a hand tool. The hand tool comprises a first jaw assembly comprising a first handle portion, a first jaw portion, and a first pivot portion disposed between the first handle portion and the first jaw portion. The first jaw portion comprises a first cutting edge. The hand tool further comprises a second jaw assembly comprising a second handle portion, a second jaw portion, and a second pivot portion disposed between the second handle portion and the second jaw portion. The second jaw portion comprises a second cutting edge. The first cutting edge and the second cutting edge are configured to operate as a wire cutter. At least one of the first cutting edge and the second cutting edge comprises a ceramic coating having a resistivity of at least at least 1.0×10⁸ Ω·cm.

In an eighteenth aspect, embodiments of the present disclosure relate to the hand tool according to the seventeenth aspect in which the resistivity is in a range of 1.0×10⁸ Ω·cm to 1.0×10¹⁴ Ω·cm.

In an nineteenth aspect, embodiments of the present disclosure relate to the hand tool according to the seventeenth aspect or the eighteenth aspect in which the ceramic coating comprises a thickness is in a range from 0.01 mm to 1 mm.

In a twentieth aspect, embodiments of the present disclosure relate to the hand tool according to the any of the seventeenth aspect to the nineteenth in which each of the first cutting edge and the second cutting edge comprise a first surface and a second surface. The first surfaces each being at an angle in a range of 300 to 750 relative to the respective second surfaces, and the second surfaces are in different planes such that the first cutting edge and the second cutting edge are in a bypass configuration.

In a twenty-first aspect, embodiments of the present disclosure relate to the hand tool according to any of the twentieth aspect in which the cutting edge comprises a radius of curvature in a range of 0.02 to 0.09 mm between each first surface and the respective second surface of the first cutting edge and of the second cutting edge.

In a twenty-second aspect, embodiments of the present disclosure relate to a hand tool. The hand tool comprises a first jaw assembly comprising a first handle portion, a first jaw portion, and a first pivot portion disposed between the first handle portion and the first jaw portion. The first jaw portion comprises a first cutting edge. The hand tool also comprises a second jaw assembly comprising a second handle portion, a second jaw portion, and a second pivot portion disposed between the second handle portion and the second jaw portion. The second jaw portion comprises a second cutting edge. The first cutting edge and the second cutting edge are configured to operate as a wire cutter. Each of the first cutting edge and the second cutting edge comprises a first surface and a second surface in which the first surface is arranged at an angle in a range from 30° to 75° with respect to the second surface. Each of the first cutting edge and the second cutting edge comprises a rounded edge connecting the first surface to the second surface. The rounded edge of each of the first cutting edge and of the second cutting edge comprises a depth of material removal in a range of 0.045 mm to 0.095 mm. The depth of material removal corresponds to a distance from a theoretical sharp edge to the rounded edge along a line bisecting the angle between the first surface and the second surface. The theoretical sharp edge corresponds to an intersection of a first plane extending from the first surface and a second plane extending from the second surface.

In a twenty-third aspect, embodiments of the disclosure relate to the hand tool according to the twenty-second aspect in which the second surfaces are in different planes such that the first cutting edge and the second cutting edge are in a bypass configuration.

In a twenty-fourth aspect, embodiments of the disclosure relate to the hand tool according to the twenty-second aspect or the twenty-third aspect in which a radius of curvature of the rounded edge is in a range of 0.02 mm to 0.09 mm.

In a twenty-fifth aspect, embodiments of the disclosure relate to the hand tool according to the twenty-fourth aspect in which the radius of curvature of the rounded edge is in a range of 0.03 mm to 0.08 mm.

In a twenty-sixth aspect, embodiments of the disclosure relate to the hand tool according to any of the twenty-second aspect to the twenty-fifth aspect in which the first cutting edge and the second cutting edge exhibit edge wear of 0.05 mm or less after 100 cutting cycles of the wire cutting.

In a twenty-seventh aspect, embodiments of the disclosure relate to the hand tool according to any of the twenty-second aspect to the twenty-sixth aspect in which the first cutting edge and the second cutting edge exhibit edge wear of 0.1 mm or less after 5000 cutting cycles of the wire cutter.

In a twenty-eighth aspect, embodiments of the disclosure relate to the hand tool according to any of the twenty-second aspect to the twenty-seventh aspect in which a cutting torque required to actuate the wire cutter is 200 in·lb or less.

In a twenty-ninth aspect, embodiments of the disclosure relate to the hand tool according to any of the twenty-second aspect to the twenty-eighth aspect in which, for each of the first cutting edge and the second cutting edge, the first surface is arranged at an angle in a range from 45° to 60° with respect to the second surface.

In a thirtieth aspect, embodiments of the disclosure relate to the hand tool according to any of the twenty-second aspect to the twenty-ninth aspect in which the hand tool is one of a wire stripper, a lineman's pliers, or a diagonal pliers.

Additional features and advantages will be set forth in the detailed description which follows, and, in part, will be readily apparent to those skilled in the art from the description or recognized by practicing the embodiments as described in the written description included, as well as the appended drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments.

### BRIEF DESCRIPTION OF THE DRAWINGS

This application will become more fully understood from the following detailed description, taken in conjunction with the accompanying figures, wherein like reference numerals refer to like elements in which:

FIG. 1 depicts a wire stripper in a closed state, according to an exemplary embodiment;

FIG. 2 depicts a wire stripper in an open state, according to an exemplary embodiment;

FIGS. 3A and 3B depict embodiments of a coating applied to one or more surfaces of a cutting edge of a wire cutter, according to exemplary embodiments;

FIGS. 4A and 4B depict a cutting edge in an as-ground and with an edge preparation, respectively, according to exemplary embodiments;

FIGS. 5A-5C depict a cutting edge in the as-ground state, edge prepped through sand blasting, and edge prepped through spinning brush wheel, respectively, according to exemplary embodiments;

FIG. 6 depicts material removal required to prepare a cutting edge from the as-ground state to a rounded edge, according to an exemplary embodiment;

FIGS. 7A and 7B depict the calculation of the depth of material removal needed to produced a rounded edge of a desired radius of curvature, according to exemplary embodiments;

FIG. 8 depicts cutting edges of a wire cutter in a bypass configuration, according to an exemplary embodiment;

FIG. 9 depicts a second cutter of the hand tool, according to an exemplary embodiment;

FIG. 10 depicts an exploded view of a hand tool formed in a separate tool head and hand portions using metal injection molding, according to an exemplary embodiment;

FIGS. 11A-11C depict coated cutting edges of a wire cutter after cutting a test wire to determine durability of the coating on the cutting edges for three experimental samples;

FIGS. 12A and 12B depict an as-ground cutting edge and a rounded cutting edge, respectively, after cutting an aircraft cable showing the depth of deformation along the cutting edges;

FIGS. 13A-13F depict a variety of cutting edges, including angled at 60° and 45° prepared by sand blasting the cutting edge, a chamfered edge, and a rounded edge, after 12 ga steel durability performance testing;

FIGS. 14A-14E depict edge profile measurements in regions of an as-ground cutting edge;

FIGS. 15A-15E depict edge profile measurements in regions of a rounded cutting edge prepared through polishing with a brush wheel, according to an embodiment of the present disclosure;

FIGS. 16A-16C depict edge profile measures in regions of a rounded cutting edge prepared through sand blasting, according to an embodiment of the present disclosure;

FIG. 17 is a plot of average cutting torque based on edge radius, including as-ground edges and rounded cutting edges according to embodiments of the present disclosure;

FIGS. 18A and 18B are plots of edge wear for 100 cutting cycles (FIG. 18A) and 5000 cutting cycles (FIG. 18B) based on edge radius, including as-ground edges and rounded cutting edges according to embodiments of the present disclosure;

FIGS. 19A and 19B depict edge wear for an as-ground edge after 100 cutting cycles and after 5000 cutting cycles;

FIGS. 20A and 20B depict edge wear for a rounded edge according to an embodiment of the present disclosure after 100 cutting cycles and after 5000 cutting cycles;

FIG. 21 is a 3D scanner image of an as-ground edge showing the chips and cuts in the ground edge; and

FIG. 22 is a 3D scanner image of a rounded edge according to an embodiment of the present disclosure showing the shape of the rounded edge.

### DETAILED DESCRIPTION

Referring generally to the figures, various embodiments of a hand tool including a wire cutter are provided. According to exemplary embodiments, the hand tool may be a wire stripper, lineman's pliers, or diagonal pliers, for example. The wire cutter includes two cutting edges that are coated and/or edge prepped to avoid electrical blowout and enhance durability. As will be discussed more fully below, the wire cutter may include a ceramic coating, such as a mixture of alumina and titania, selected to provide a good balance of electrical resistivity and toughness. In particular, the coating significantly reduces the likelihood or may even prevent electrical blowout when a user of the hand tool accidentally cuts a live wire. Additionally or alternatively, the cutting edge of the wire cutter may undergo an edge preparation technique, such as sand blasting or brush wheel polishing, to provide a rounded edge with little to no edge defects that can act as initiation points for failure during wire cutting operations. These and other aspects and advantages will be discussed more fully in relation to the embodiments provided below and depicted in the figures. These embodiments are provided by way of illustration, not limitation.

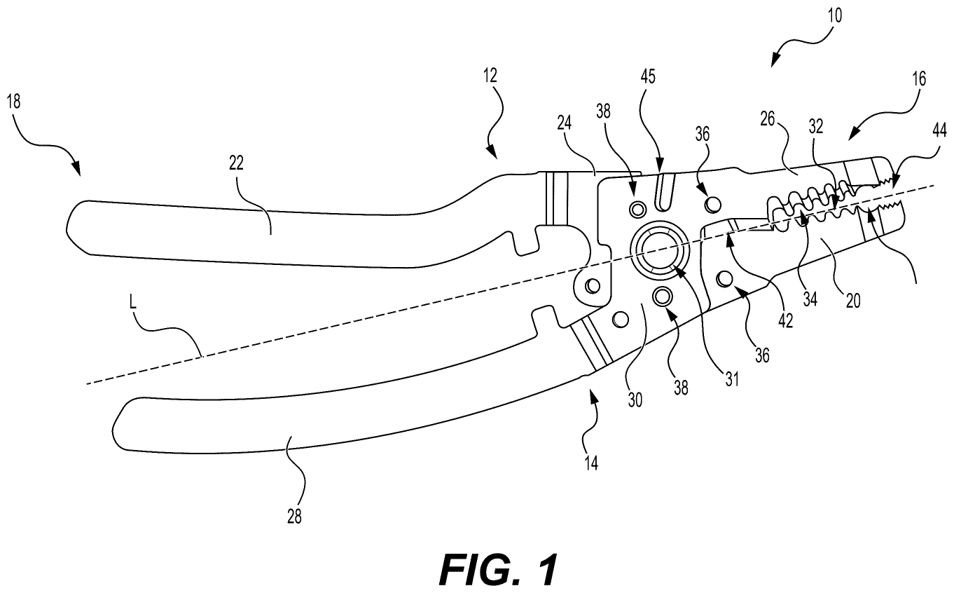

FIG. 1 illustrates an example embodiment of a hand tool, such as a wire stripper 10, according to the present disclosure. The wire stripper 10 includes a first jaw assembly 12 and a second jaw assembly 14. Each jaw assembly 12, 14 has a jaw end 16 and a handle end 18.

The first jaw assembly 12 includes a first jaw portion 20 and a first handle portion 22. Disposed between the first jaw portion 20 and the first handle portion 22 is a pivot portion 24. Similarly, the second jaw assembly 14 includes a second jaw portion 26 and a second handle portion 28. Disposed between the second jaw portion 26 and the second handle portion 28 is a second pivot portion 30. The first jaw assembly 12 is pivotably connected to the second jaw assembly 14. In particular, each jaw assembly includes a pivot aperture 31 through which a pivot pin (not shown) is inserted. In this way, a user can open and close the handle portions 22, 28 to open and close the jaw portions 20, 26.

In particular, the pivot portions 24, 30 include a top half and a bottom half as divided by longitudinal axis L. As can be seen in FIG. 1, the first handle portion 22 extends from the top half of one side of the first pivot portion 24, and the first jaw portion 20 extends from the bottom half of the other side of the first pivot portion 24. Further, the second handle portion 28 extends from the bottom half of one side of the second pivot portion 30, and the second jaw portion 26 extends from the top half of the other side of the second pivot portion 30. By opening the handle portions 22, 28 about the pivot portions 24, 30, the jaw portions 20, 26 are opened, and by closing the handle portions 22, 28 about the pivot portions 24, 30, the jaw portions 20, 26 are closed.

The first jaw portion 20 includes a plurality of first aperture portions 32, and the second jaw portion 26 includes a corresponding plurality of second aperture portions 34. When the jaw portions 20, 26 close, the plurality of first aperture portions 32 and the corresponding plurality of second aperture portions 34 cooperate to form wire stripper apertures. The wire stripper apertures are provided in a plurality of sizes corresponding to different gauges of wires. When the handle portions 22, 28 are squeezed together, the wire stripper apertures cut deep enough into the wire to penetrate the insulating jacket material but not so deep as to cut the metal core (whether solid wire or stranded wires), and thereafter, the wire is pulled through the wire stripper aperture to remove the insulating material from the end of the wire, exposing the metal core. In one or more embodiments, the apertures 32, 34 are configured to strip wires having a gauge in the range of 10 to 18 AWG for solid wire, or 12 to 20 AWG for stranded wire.

The wire stripper 10 may include additional tools, such as one or more wire loop holes 36, one or more bolt/screw shearing holes 38, a screw head clamp 40, a wire cutter 42, a plier tip 44, and a second cutter 45.

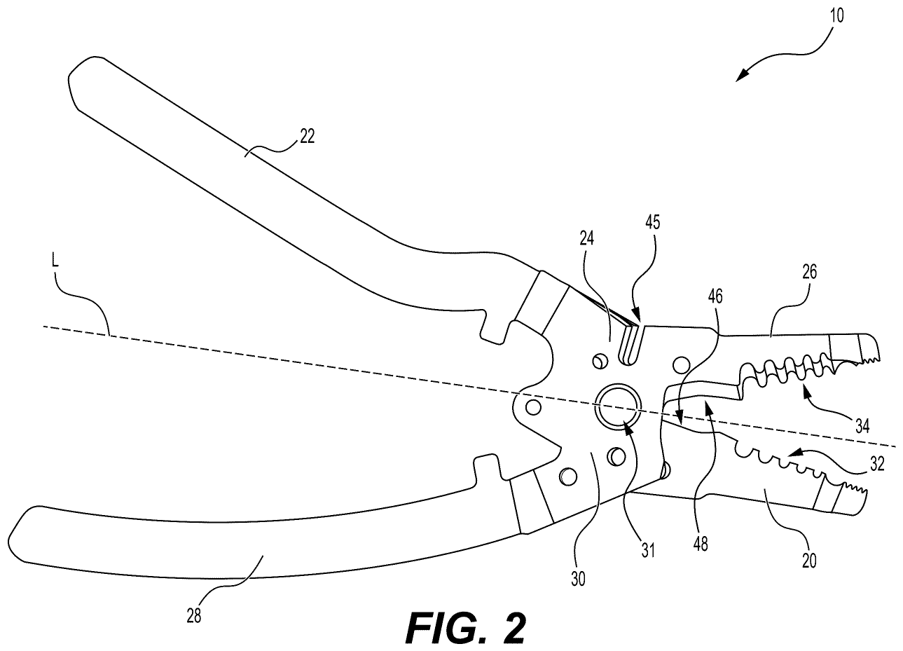

With reference to FIG. 2, the wire stripper 10 is shown in an open position. As can be seen in FIG. 2, the wire cutter 42 includes a first cutting edge 46 on the first jaw portion 20 of the first jaw assembly 12 and a second cutting edge 48 on the second jaw portion 26 of the second jaw assembly 14. In particular, the first cutting edge 46 is disposed between the plurality of first aperture portions 32 and the first pivot portion 24, and the second cutting edge 48 is disposed between the corresponding plurality of aperture portions 34 and the second pivot portions 30. According to the present disclosure, the cutting edges 46, 48 are coated with a ceramic material to avoid electrical blowout if the wire cutter 42 is accidentally used to cut a live wire and/or edge prepped to provide a wire cutter 42 that maintains its edge without chipping or cracking over long periods of use.

Referring first to the coating, at least one of the first cutting edge 46 or the second cutting edge 48 is coated with a ceramic coating having an electrical resistivity of at least 10⁸ Ω·cm, at least 10⁹ Ω·cm, at least 10¹⁰ Ω·cm, at least 10¹¹ Ω·cm, at least 10¹² Ω·cm, or at least 10¹³ Ω·cm. In one or more embodiments, the ceramic coating has an electrical resistivity of up to at least 10¹⁴ Ω·cm. In one or more embodiments, the ceramic coating has an electrical resistivity in a range of 10⁸ Ω·cm to 10¹⁴ Ω·cm. Advantageously, the ceramic coating is configured to limit current flow and avoid brittle cracking and chipping.

An example of such a ceramic coating is an alumina-titania coating. In this exemplary coating, titania (TiO₂) is more ductile than alumina (Al₂O₃), but titania is also more conductive than alumina. In particular, titania has an electrical resistivity of about 10⁸ Ω·cm, which is on the level of a semi-conductor, whereas alumina has an electrical resistivity of 10¹⁴ Ω·cm, making alumina an electrical insulator. Despite the desirable electrical resistivity, alumina by itself, though, is too brittle for use as a cutting edge. According to one example embodiment of the ceramic coating, a combination of titania and alumina for the coating of the cutting edges 46, 48 provides not only sufficient electrical resistivity to prevent current leakage into the wire stripper 10, thereby preventing blowout, but also enhanced mechanical performance to withstand repeated shearing without chipping or cracking, especially after undergoing edge preparation as discussed more fully below.

In one or more embodiments of the exemplary alumina-titania ceramic coatings, the ceramic coating on the at least one of the first cutting edge 46 or the second cutting edge 48 comprises primarily alumina by weight, in particular at least 60 wt % alumina. In one or more embodiments, the coating comprises up to 90 wt % alumina, in particular up to 87 wt % alumina. In one or more embodiments, the coating comprises the balance of titania, including up to 0.5 wt % each of impurities and a total impurity content of 5 wt % or less. For example, in one or more embodiments, the alumina-titania ceramic coating comprises titania in an amount in a range from 10 wt % to 40 wt %, in particular in a range from 13 wt % to 40 wt %.

It should be noted that other ceramic coatings, comprising a single component or a mixture of components, meeting the desired electrical resistivity and toughness may be used instead of alumina-titania and that alumina-titania is just one example of such a ceramic coating.

In one or more embodiments, the ceramic coating is applied to the cutting edge 46, 48 using a thermal spray coating process. In one or more embodiments, the thermal spray coating process is selected from plasma spray, high velocity oxygen fuel (HVOF) coating, and combustion spray coating.

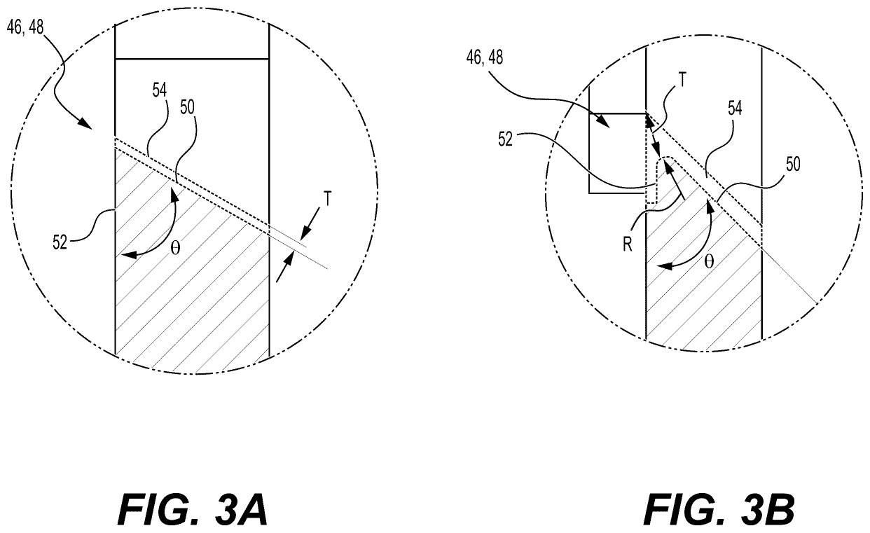

With reference to FIGS. 3A and 3B, a cutting edge, which is representative of both the first cutting edge 46 and the second cutting edge 48, is shown. As can be seen, the cutting edge 46, 48 includes a first surface 50 and a second surface 52. In one or more embodiments, the first surface 50 forms an acute angle with respect to the second surface 52. In one or more particular embodiments, the first surface 50 forms an angle θ in a range of about 30° to about 75°, in particular about 450 to about 60°, most particularly about 520 to about 58°, relative to the second surface 52. In one or more embodiments, the ceramic coating 54 is applied to a first surface 50 of the cutting edge 46, 48 as shown in FIG. 3A, and in one or more other embodiments, the coating 54 is applied to the first surface 50 and the second surface 52 of the cutting edge 46, 48 as shown in FIG. 3B.

Further, as shown in FIGS. 3A and 3B, the coating 54 has a thickness T. In one or more embodiments, the thickness T is in a range from 0.01 mm to 1 mm, in particular in a range of 0.1 mm to 0.6 mm, and most particularly in a range of 0.13 mm to 0.51 mm. In one or more embodiments, the thickness T is about 0.25 mm. In the embodiment shown in FIG. 3A in which the coating is applied to the first surface 50, the thickness T of the coating 54 is measured as the perpendicular distance between the outer surface of the coating 54 and the underlying jaw portion 20, 26. In the embodiment shown in FIG. 3B in which the coating 54 is applied to the first surface 50 and the second surface 52, the thickness T of the coating is measured from the tip of the coating 54 to the tip of the jaw portion 20, 26 at an angle bisecting the angle between the first surface 50 and the second surface 52. As shown in FIG. 3B, the tip between the first surface 50 and the second surface 52 may be rounded, and the tip of the coating 54 may also be rounded as discussed below, but the measurement of the thickness will be the same.

Having described the coating 54, preparation of the cutting edge 46, 48 is now described. As mentioned above, the cutting edge 46, 48 may be prepped in conjunction with providing the ceramic coating 54 or independently of providing a ceramic coating 54. That is, aspects of the present disclosure relate to providing a ceramic coating on a cutting edge 46, 48 of a wire cutter 42, and other aspects of the present disclosure relate to edge prepping of the cutting edges 46, 48 of a bypass-style wire cutter 42. Additionally, aspects of the present disclosure relate to cutting edges 46, 48 having the ceramic coating 54 and also being edge prepped as described below.

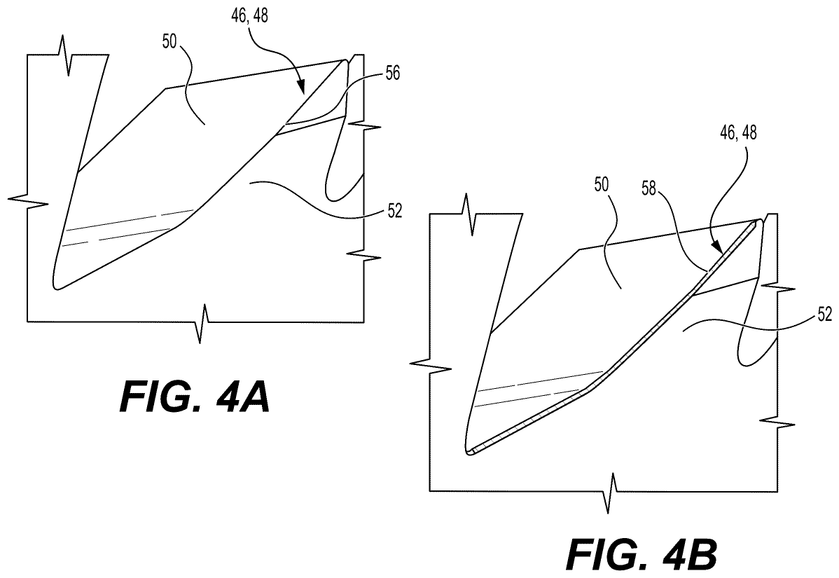

FIGS. 4A and 4B depict the cutting edge 46, 48 in the as-ground state 56 and after edge prepping to form a rounded edge 58. In the as-ground state, the cutting edge 46, 48 is in the state after the angle between the first surface 50 and the second surface 52 is formed, e.g., by grinding or other material removal processes, which provides a sharp edge. However, sharp edges tend to contain edge defects, such as small chips or cracks, that can be initiation points for larger defects when the cutting edge 46, 48 is stressed. According to the present disclosure, such edge defects are removed and prevented by abrading the edge to produce a rounded edge 58 as shown in FIG. 4B.

In one or more embodiments, the rounded edge 58 is produced by sand blasting the as-ground cutting edge 46, 48 or by polishing the cutting edge 46, 48 with a spinning brush wheel. In one or more embodiments, sand blasting is performed by sand blasting back and forth across the ground cutting edge 46, 48 for, e.g., 20 seconds to abrade away the sharp edge. In one or more other embodiments, polishing using a spinning brush wheel is performed by clamping each jaw assembly to a fixture, positioning the fixture such that cutting edge 46, 48 of each of the jaw assemblies has a certain depth of contact, such as 1 mm, with respect to the bristles of the spinning brush wheel, and holding the cutting edge 46, 48 against the spinning brush wheel for, e.g., up to 1 minute.

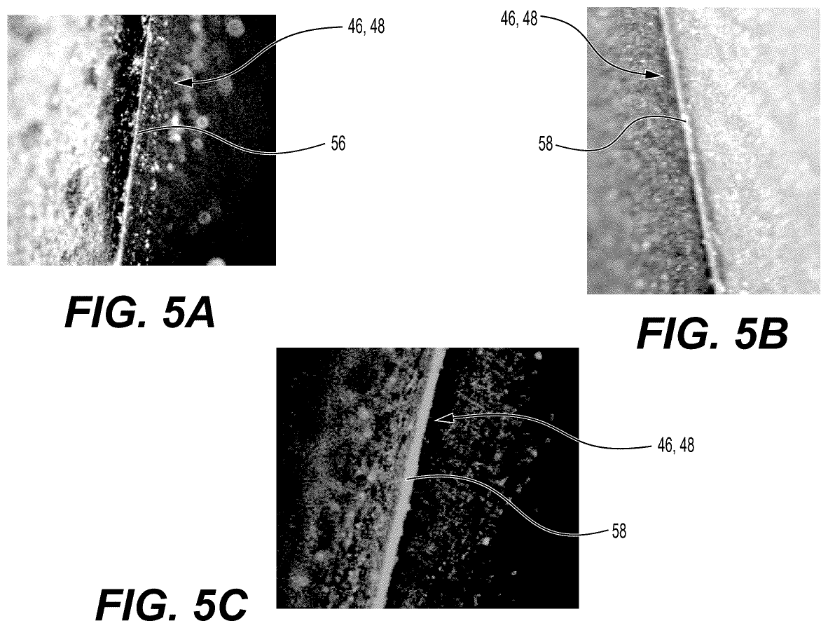

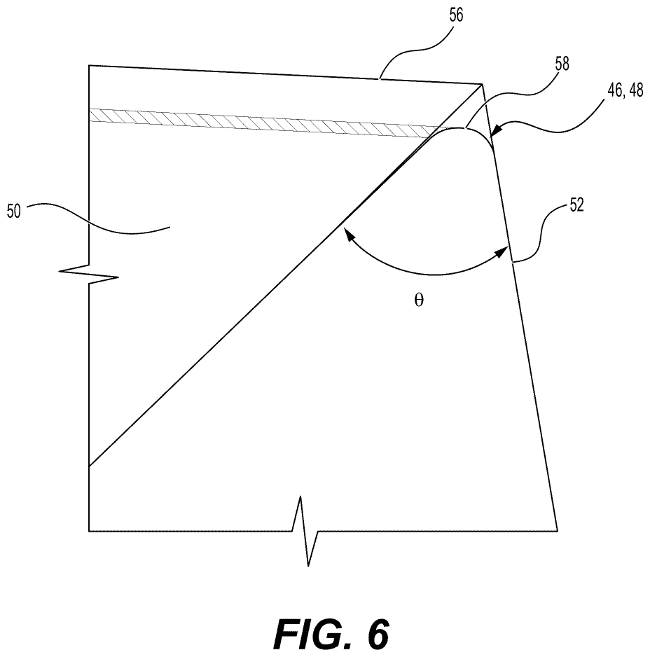

FIGS. 5A-5C depict examples of a cutting edge 46, 48 in an as-ground state 56 (FIG. 5A), rounded edge 58 after sand blasting (FIG. 5B), and rounded edge 58 after brush wheel polishing (FIG. 5C). The cutting edges 46, 48 shown in FIGS. 5A-5C each depict the metal cutting edge 46, 48 without any ceramic coating 54. FIG. 6 represents an example of edge preparation, demonstrating the material removed from the cutting edge 46, 48 in the as-ground state 56 to produce the cutting edge 46, 48 having a rounded edge 58 with a desired radius of curvature. In the embodiment depicted in FIG. 6, the angle θ of the cutting edge 46, 48 as defined by first surface 50 and the second surface 52 is about 55°, and the desired radius of curvature is 0.06±0.025 mm. In one or more embodiments, the radius of curvature is in a range of 0.02 mm to 0.09 mm, in particular 0.03 mm to 0.08 mm, and most particularly 0.04 mm to 0.06 mm. In FIG. 6, the portion of the cutting edge 46, 48 shown in phantom is the amount of material removed from the as-ground state 56 to produce the rounded edge 58 as described.

While a radius of curvature is used to describe the rounded edge 58, the rounded edge 58 may not necessarily form a perfect radiused edge; although a perfectly radiused edge is not excluded from the scope of the disclosed rounded edge 58. According to embodiments of the present disclosure, the rounded edge 58 is characterized by a radius of curvature as determined using an optical profilometer (such as a VR-6000 Series 3D Optical Profilometer, available from Keyence Corporation of America, Itasca, IL, or any other suitable optical profilometer known in the art) and applying a best fit circle to the scanned rounded edge 58. The radius of the best fit circle from the scanned rounded edge 58 corresponds to the radius of curvature as discussed above.

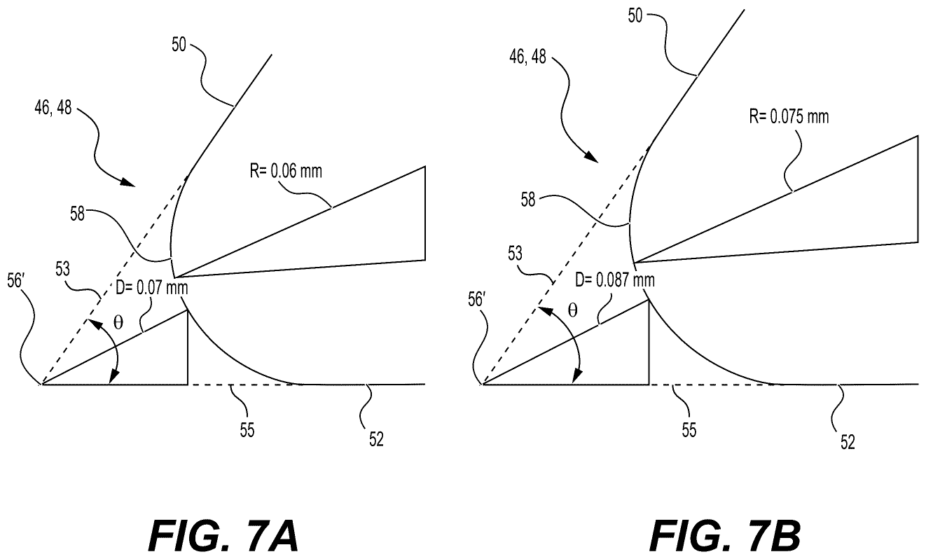

FIGS. 7A and 7B demonstrate another manner of characterizing the cutting edge 46, 48 based on the depth D of material removed from a theoretical sharp edge 56′ to produce the desired rounded edge 58. As shown in FIG. 7A, the nominal radius of curvature R for the rounded edge 58 is 0.06 mm, and the angle θ between the first surface 50 and the second surface 52 is 55°. The depth D of material removal from the theoretical sharp edge 56′ to provide the rounded edge 58 is determined by extending a first plane 53 from the first surface 50 and extending a second plane 55 from the second surface 52 until the planes 53, 55 intersect at the theoretical sharp edge 56′. The planes intersect at the angle θ of the cutting edge 46, 48, and the distance D of material removal is measured along the line bisecting the angle θ from the theoretical sharp edge 56′ to the rounded edge 58. As shown in FIG. 7A, the material removal of the cutting edge 46, 48 to form the rounded edge 58 corresponds to a depth D of 0.07 mm. FIG. 7B shows the same calculation for the radius of curvature R of 0.075 mm. As can be seen, to produce the larger radius of curvature R, the depth D of material removal material from the theoretical sharp edge 56′ to a depth D of 0.087 mm. In one or more embodiments, the depth D of material removal from a theoretical sharp edge 56′ to produce the desired rounded edge 58 is in a range of 0.045 mm to 0.095 mm for surfaces 50, 52 arranged at an angle in a range of 52° to 58° and having a rounded edge 58 with a nominal radius of curvature R in a range of 0.04 mm to 0.08 mm.

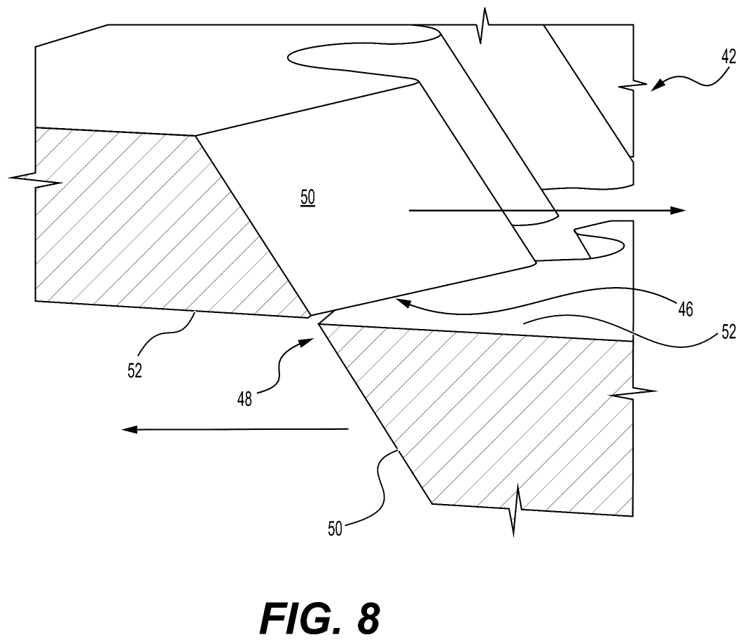

FIG. 8 depicts the cutting edges 46, 48 of the wire cutter 42 in a bypass configuration. In such a configuration the cutting edges 46, 48 do not meet at the end of a cutting action. Instead, the cutting edges 46, 48 are offset a sufficient amount such that they cutting edges 46, 48 do not lie in the same plane. In one or more embodiments, the cutting edges 46, 48 are positioned such that the second surface 52 of each cutting edge 46, 48 contact each other at the end of a cutting action. Advantageously, cutting edges 46, 48 in the bypass configuration provide a cleaner cut as opposed to anvil-style cutters that tend to deform the cut end of the workpiece.

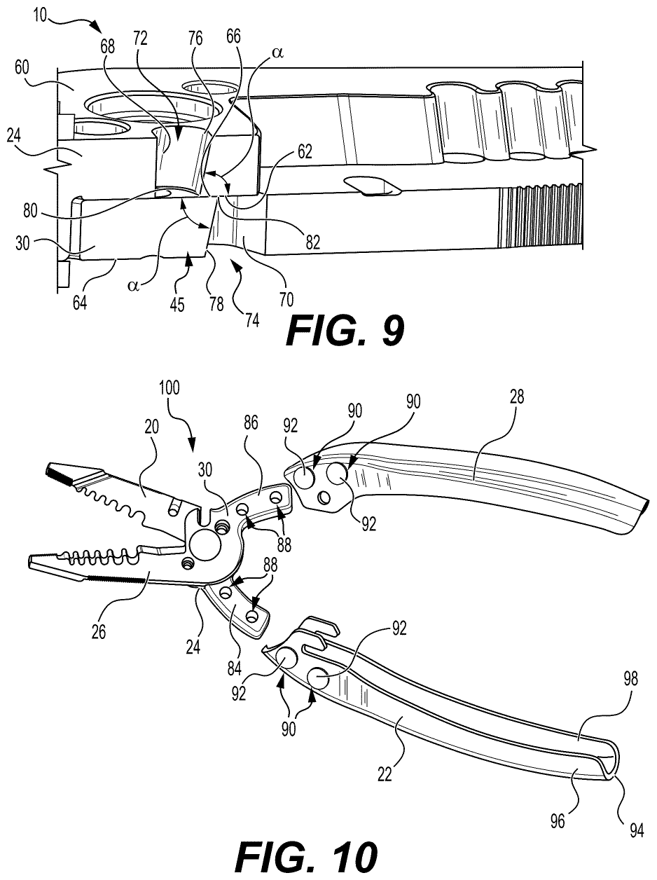

In one or more embodiments, including the embodiment shown in FIG. 9, the hand tool 10 includes a second cutter 45 formed by the pivot portions 24, 30. In particular, the first pivot portion 24 includes a first exterior surface 60 and a first interior surface 62, and the second pivot portion 30 includes a second exterior surface 64 and a second interior surface 66. As can be seen, the first pivot portion 24 includes a first transverse surface 68 connecting the first exterior surface 60 and the first interior surface 62, and the second pivot portion 30 includes a second transverse surface 70 connecting the second exterior surface 64 and the second interior surface 66. The first transverse surface 68 defines a first cutting recess 72, and the second transverse surface 70 defines a second cutting recess 74. When the hand tool 10 is in the open position, the first cutting recess 72 is aligned with the second cutting recess 74 so that the cutting recesses 72, 74 can receive a wire to be cut, and closing the hand tool 100 causes the second cutter 45 to cut the wire disposed in the recesses 72, 74. Applicant has found that providing a second cutter 45 in the pivot portions 24, 30 allows for improved leverage and durability for cutting metal wires.

In one or more embodiments, the first transverse surface 68 includes a first cutting section 76, and the second transverse surface 70 includes a second cutting section 78. The first cutting section 76 of the first transverse surface 68 forms an angle α with respect to the first interior surface 62 and defines a first cutting edge 80, and the second cutting section 78 of the second transverse surface 70 also forms the angle α with respect to the second interior surface 66 and defines a second cutting edge 82. In one or more embodiments, the angle α is in a range of 75° to 85°, in particular in a range of 77° to 83°, and most particularly in a range of 79° to 81°. As can be seen, the second cutter 45 is a bypass cutter in which the first interior surface 62 moves past the second interior surface 66 such that the first cutting edge 80 and the second cutting edge 82 do not meet.

In one or more embodiments, the cutting edges 80, 82 of the second cutter 45 are edge prepped to form a rounded edge as described above in relation to the wire cutter 42. Further, in one or more embodiments, the cutting edge 80, 82 of the second cutter 45 are additionally or alternatively provided with a ceramic coating to reduce or eliminate the risk of electrical blowout.

In one or more embodiments, the hand tools disclosed herein include at least jaw portions 20, 26 formed using a metal injection molding (“MIM”) process. In one or more such embodiments, the jaw portions 20, 26 may be coupled to separate handle portions 22, 28. Hand tools of the type described herein are conventionally formed by stamping or forging the head and handle as a single, integral piece of metal. However, according to one or more embodiments of the present disclosure, the hand tools may be formed using MIM, which allows for wire strippers having chosen dimensions with tighter tolerances compared to wire strippers formed using stamping or forging processes. The MIM process may allow for more desirable stiffness and hardness of the jaw portions 20, 26 compared to conventional wire strippers, which may be limited as a result of post-process machining requirements for conventional wire strippers. In one or more embodiments, a hot isostatic pressing (“HIP”) process can be performed after MIM forming to increase the density of the hand tool, in particular the jaw portions 20, 26, which may provide a desirable stiffness and strength. The MIM and HIP processes described can be used in conjunction with the ceramic coating and edge prepping to further enhance the hand tools according to the present disclosure; however, the ceramic coating and edge prepping may be used as well to enhance stamped hand tools.

The HIP process allows for desirable stiffness from the MIM process along with strength similar to forged wire strippers. For example, in various specific embodiments, wire stripper 10 has a density of about 97% following the MIM process. In such an embodiment, wire stripper 10 has a density of about 99.9% following the HIP process. In various specific embodiments, the jaw portions 20, 26 have an ultimate tensile strength in a range of 2100 MPa to 2500 MPa, in particular in a range of 2185 MPa to 2415 MPa.

In one or more embodiments, the MIM process allows for the manufacture of the handle portions 22, 28 separate from the jaw portions 20, 26 and pivot portions 24, 30 as shown in the exploded view of FIG. 10. In one or more embodiments, attachment portions 84, 86 extend from a side of the pivot portions 24, 30 opposite to the jaw portions 20, 26. In one or more embodiments, the attachment portions 84, 86 include one or more through holes 88 for attaching the handle portions 22, 28. In one or more such embodiments, the handle portions 22, 28 include corresponding through holes 90, and the handle portions 22, 28 are attached to the attachment portions 84, 86 using a fastener 92, such as a rivet as shown in FIG. 10. In one or more such embodiments, the handle portions 22, 28 may each have a trough shape with a central wall 94 connecting a first sidewall 96 and a second sidewall 98. The attachment portions 84, 86 are inserted between the sidewalls 96, 98 of the handle portions 22, 28, and the fastener 92 is inserted through the through holes 88 of the attachment portions 84, 86 and through the corresponding through holes 90 of the handle portions 22, 28.

Together, the jaw portions 20, 26, pivot portions 24, 30, and the attachment portions 84, 86 may be collectively referred to as tool head 100. In one or more embodiments, the tool head is formed from a first material, and the handle portions 22, 28 are formed from a second material that is different than the first material. In one or more embodiments, the tool head 100 is formed from the first metal material having a first density, and the handle portions 22, 28 are formed from a second metal material having a second density that is less than the first density. For example, the tool head 100 may be made from a steel alloy, such as 100Cr6, 440C, or tool steel S7, and the handle portions 22, 28 are formed from one of an aluminum alloy, a magnesium alloy, or a titanium alloy.

In one or more embodiments, the tool head 100 prepared using the MIM process comprises a stiffness or a spring constant in a range from 450 N/mm to 550 N/mm, in particular in a range of 475 N/mm to 525 N/mm, and most particular in a range of 500 N/mm to 520 N/mm. In such embodiments, the spring constant is measured when a force is applied in a direction parallel to the pivot axis of the hand tool. In one or more embodiments, the tool head 100 comprises a hardness greater than 59 HRC (Rockwell C hardness), in particular in a range from 59 to 64 HRC, more particularly in a range from 60 to 63 HRC, and most particularly in a range from 60 to 62 HRC. In one or more embodiments, this level of hardness is achieved using the MIM process to prepare the tool head. In one or more embodiments, the level of hardness can be achieved locally in regions by localized induction hardening. In one or more such embodiments, the localized hardening is achieved for a depth in the range of 0.5 mm to 5 mm in the surface of the tool head 100.

While the foregoing description has been framed in terms of a wire cutter on a wire stripper 10, the wire cutter can instead be part of another hand tool, such as lineman's pliers or diagonal pliers, for example.

### Experimental Examples

As will be discussed in the following examples, the wire stripper 10 with the coating 54 applied to the cutting edges 46, 48 were tested for current leakage, resistance to blowout, and durability. According to the present disclosure, “blowout” occurs when an unintended path of low electrical resistance is created between two conductors, such as between a current carrying wire and a cutting edge of a wire cutter 42. This can occur if a user of the wire stripper 10 accidentally cuts a live wire, which can create a sudden surge in current, generating heat and potentially causing damage to the electrical components and/or wire stripper 10.

Starting with current leakage, eight total samples (Samples 1-8) were prepared in which the cutting edges 46, 48 were coated with four materials TiO₂, Al₂O₃-40% TiO₂, Al₂O₃-13% TiO₂, and Al₂O₃. Two samples of each material were prepared using plasma coating (1) and combustion coating (2). Current leakage on each cutting edge 46, 48 (CE1 and CE2) was determined by touching the cutting edges to a live wire energized at 120 V, 240 V, 480 V, and 1 kV. The results of the current leakage testing are summarized in Table 1, below. As used in the table, “L” means current leakage, “M” means minimal current leakage, and “N” means no current leakage.

TABLE 1
Current Leakage Testing

| | Coating | | Cutting | | | | |
|---|---|---|---|---|---|---|---|
| Sample | Technique | Material | Edge | 120 V | 240 V | 480 V | 1 kV |
| 1 | 1 | TiO₂ | CE1 | L | L | L | L |
| | | | CE2 | L | L | L | L |
| 2 | 2 | | CE1 | L | L | L | L |
| | | | CE2 | L | L | L | L |
| 3 | 1 | Al₂O₃- | CE1 | N | L | L | L |
| | | 40% | CE2 | N | L | L | L |
| 4 | 2 | TiO₂ | CE1 | L | L | L | L |
| | | | CE2 | L | L | L | L |
| 5 | 1 | Al₂O₃- | CE1 | N | N | M | L |
| | | 13% | CE2 | N | N | M | L |
| 6 | 2 | TiO₂ | CE1 | N | N | M | L |
| | | | CE2 | N | N | M | L |
| 7 | 1 | Al₂O₃ | CE1 | N | N | N | L |
| | | | CE2 | N | N | M | L |
| 8 | 2 | | CE1 | N | N | M | L |
| | | | CE2 | N | N | M | L |

From Table 1, it can be seen that the coating of TiO₂ alone was not able to prevent current leakage. However, when the coating included 60 wt % Al₂O₃ and above, the coating started to prevent current leakage at 120 V, in particular when the coating was applied using plasma coating. At 87 wt % Al₂O₃, the coating prevented current leakage at 120 V and 240 V, and there was minimal current leakage at 480 V. The 1 kV voltage was used as a reference voltage, and none of the coatings were able to prevent current leakage at this voltage level.

To confirm and correlate the current leakage results to an actual blowout scenario, wire cutters corresponding to the same eight samples (four materials with two coating techniques) were used to cut actual live wires energized at 120 V to determine resistance to blowout. Table 2 summarizes the results, below. In Table 2, “N” represents no blowout, and “Y” represents blowout.

TABLE 2
Summary of Blowout Testing

| | Coating | | Cutting | Blowout |
|---|---|---|---|---|
| Sample | Technique | Material | Edge | @ 120 V |
| 1 | 1 | TiO₂ | CE1 | Y |
| | | | CE2 | Y |
| 2 | 2 | | CE1 | Y |
| | | | CE2 | Y |
| 3 | 1 | Al₂O₃- | CE1 | N |
| | | 40% TiO₂ | CE2 | N |
| 4 | 2 | | CE1 | N |
| | | | CE2 | N |
| 5 | 1 | Al₂O₃- | CE1 | N |
| | | 13% TiO₂ | CE2 | N |
| 6 | 2 | | CE1 | N |
| | | | CE2 | N |
| 7 | 1 | Al₂O₃ | CE1 | N |
| | | | CE2 | N |
| 8 | 2 | | CE1 | N |
| | | | CE2 | N |

As can be seen from Table 2, the samples containing at least 60 wt % Al₂O₃ did not experience blowout when cutting a live wire energized at 120 V, which substantially corresponds to the current leakage findings from Table 1.

Based on the resistance to blowout of the alumina-titania coating, six sample wire cutters were prepared from 1075 steel blanks having a thickness of 4 mm and a base hardness of 50-55 HRC. The angle of the cutting edges 46, 48 (i.e., the angle between the first surface 50 and the second surface 52) was 60°. Two material coatings were applied, Al₂O₃-13% TiO₂ and Al₂O₃-40% TiO₂, using HVOF coating. HVOF is a coating method that uses high-pressure combustion fuel and oxygen to propel powered materials, in this case titania powder and alumina powder, at supersonic speeds onto surfaces, creating dense, durable coatings with high hardness, wear resistance, and corrosion protection. In the first three samples, only the first surface 50 was coated with the coating material, and in the second three samples both the first surface 50 and the second surface 52 were coated with the coating material. Further, in the first three samples, the cutting edge was coated as ground, but in the second three samples, cutting edge was edge prepped to provide a nominal radius of curvature of 0.1 mm. For the first three samples, the coatings were applied at three thicknesses of 0.15 mm, 0.29 mm, and 0.58 mm as measured before edge prepping, and after edge prepping, the coating thickness was 0.13 mm, 0.25 mm, and 0.51 mm. For the second three samples, the coatings were applied at three thicknesses of 0.36 mm, 0.9 mm, and 1.1 mm as measured before edge prepping, and after edge prepping, the coating thickness was 0.13 mm, 0.25 mm, and 0.51 mm. For the second three samples, the coating thickness both before and after grinding was measured from the tip of the cutting edge to the tip of the rounded steel jaw assembly (e.g., as shown in FIG. 3B).

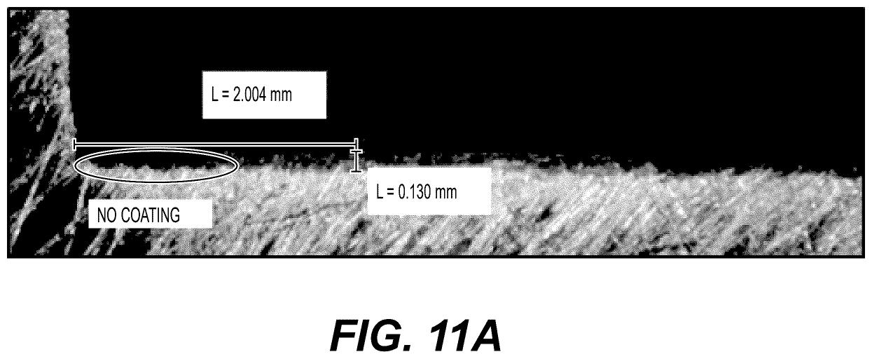

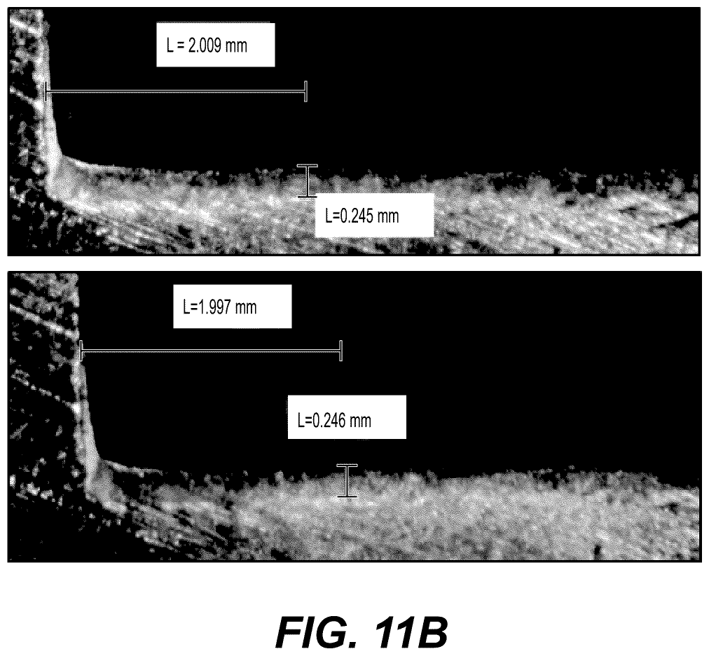

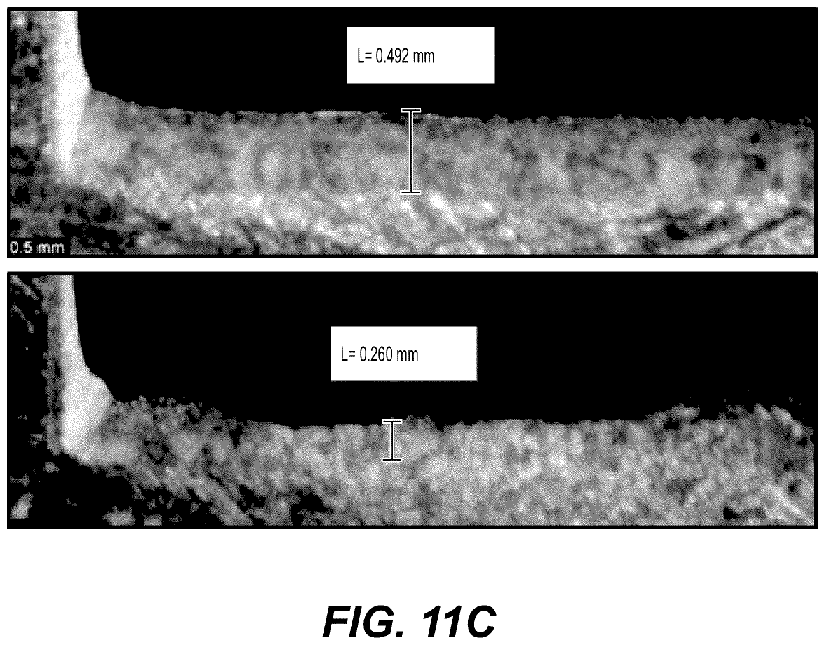

Twelve wire cutter samples were tested for durability by subjecting the wire cutters to a single cut of 8 AWG copper wire. The twelve samples included three different coating thicknesses as described above and two coating compositions (Al₂O₃-13% TiO₂ and Al₂O₃-40% TiO₂). Further, six of the samples were coated a single surface (first surface 50), and six of the samples were coated on two surfaces (first surface 50 and second surface 52). The single-sided and double-sided coating samples having the coating thickness of 0.13 mm for each of Al₂O₃-13% TiO₂ and Al₂O₃-40% TiO₂ chipped during grinding and thus were not considered to survive the durability testing. FIG. 11A depicts a cutting edge of one of the samples with the 0.13 mm thick coating after grinding, and as can be seen, there are sections where the coating is entirely removed as well as additional chips along the cutting edge.

The coating samples (Al₂O₃-13% TiO₂ and Al₂O₃-40% TiO₂) for the single-sided coating having the coating thickness of 0.25 mm were able to be ground to the desired thickness and survived the single cut of the copper wire. FIG. 11B depicts the coating of a sample having the coating thickness of 0.25 mm before (top) and after (bottom) the single cutting of the copper wire. As can be seen, the edge remains intact without any identifiable chipping or cracking of the coating along cutting edge. The coating sample for the double-sided coating of Al₂O₃-13% TiO₂ having the coating thickness of 0.25 mm chipped during grinding and assembly, and the coating sample for the double-sided coating of Al₂O₃-40% TiO₂ was able to be ground to the desired thickness but chipped during the single cut of the copper wire

Finally, the single-sided coating samples (Al₂O₃-13% TiO₂ and Al₂O₃-40% TiO₂) having the thickness of 0.51 mm were able to be ground to the desired thickness, but both samples chipped after a single cut of the copper wire. FIG. 11C depicts the coating of a sample having the coating thickness of 0.51 mm before (top) and after (bottom) the single cutting of the copper wire. As can be seen, the coating is chipped and removed in sections wherein the cut was made. In certain places along the cutting edge, the coating was removed by up to half the thickness of the coating. The double-sided coating samples of Al₂O₃-13% TiO₂ having the thickness of 0.51 mm also chipped after a single cut, and the double-sided coating sample of Al₂O₃-40% TiO₂ chipped during grinding and assembly before cutting.

In another test of durability, four samples of wire cutters (not provided with ceramic coating) with different cutting edge angles and edge preparations were prepared and used to cut 3/16″ aircraft cable. The cut force required to cut the aircraft cable was measured, and the depth of damage to the cutting edge was also measured after cutting. Table 3, below, summarizes the testing of the four samples.

TABLE 3
Cutting Performance of Wire Cutters on Aircraft Cable

| Edge Condition | Cut Force (lbf) | Damage Depth (mm) |
|---|---|---|
| 45° - as ground | 70.8 | 0.273 |
| 45° - rounded | 68 | 0.141 |
| 60° - as ground | 52 | 0.248 |
| 60° - rounded | 47.2 | 0.05 |

As can be seen from Table 3, providing a rounded edge lowered the required cut force and depth of damage for a cutting edge of a given angle than the as-ground state. In particular, for the 45° cutting edge, the depth of damage was reduced by 48% by rounding the cutting edge, and for the 60° cutting edge, the depth of damage was reduced by 80% by rounding the cutting edge. Further, Table 3 demonstrates that the cutting edge with the higher angle, 60°, required a lower cut force and decreased the depth of damage as compared to the cutting edge with the lower angle, 45°. For the rounded cutting edges of Table 3, the radius was formed by polishing using a brush wheel.

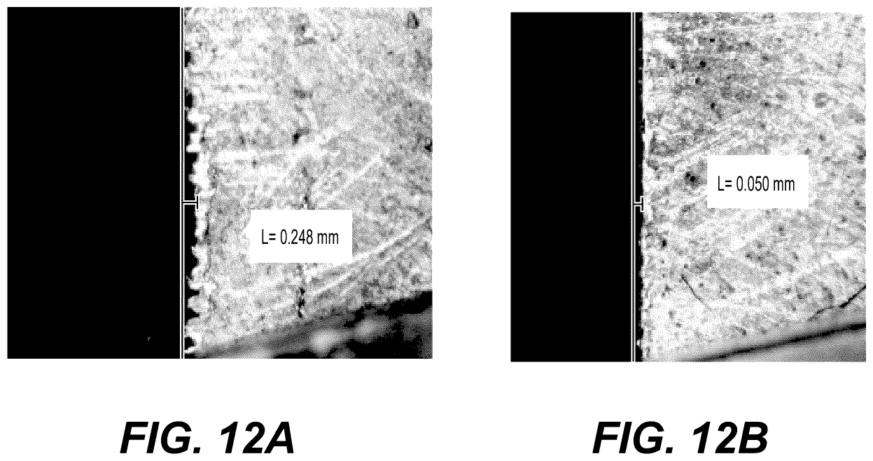

FIGS. 12A and 12B depict the 60° cutting edges of the as-ground and rounded edges, respectively, after cutting. As can be seen, after cutting the aircraft cable, the as-ground cutting edge as shown in FIG. 12A exhibits significant deformation caused by the cut, whereas the rounded cutting edge as shown in FIG. 12B exhibits minimal deformation as a result of the cut.

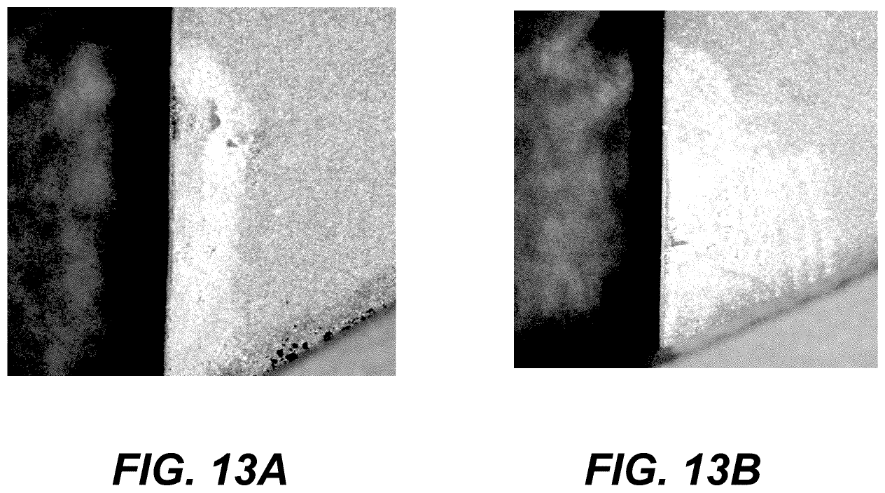

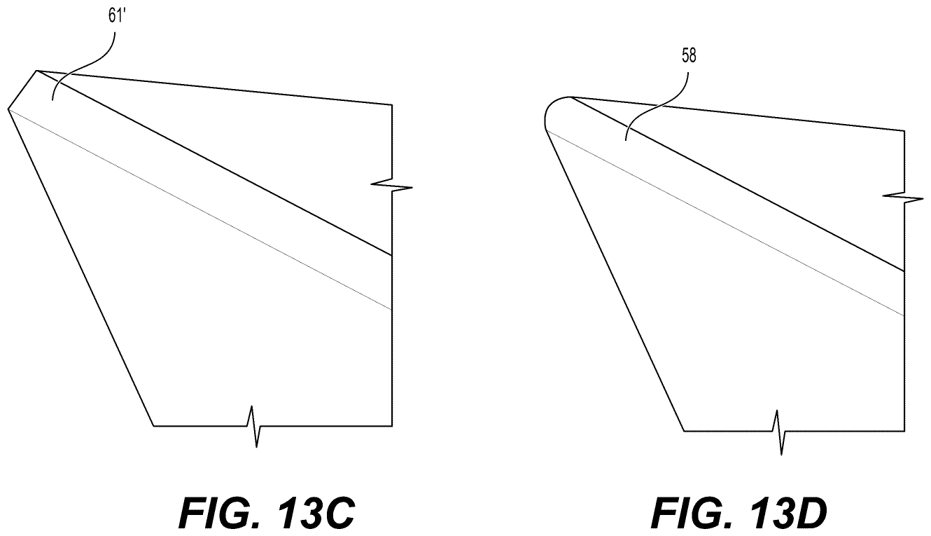

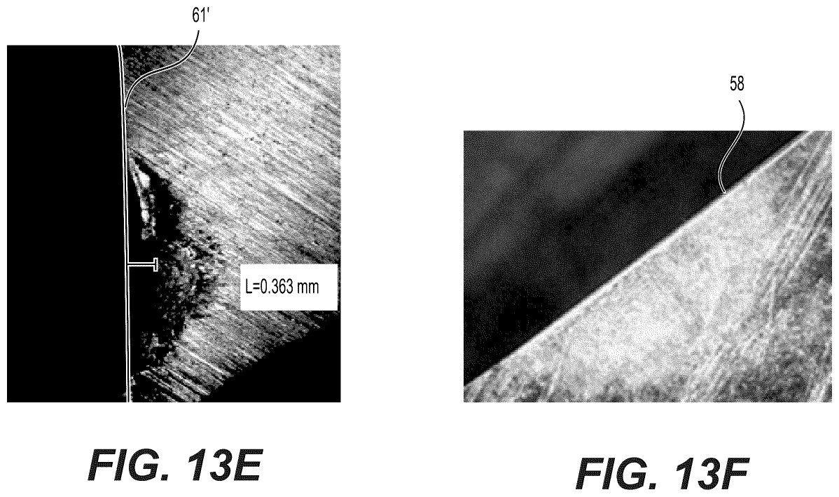

FIGS. 13A and 13B depict a cutting edge formed at 60° and 45°, respectively, after durability performance testing involving cutting 12 ga steel wire over 5000 cutting cycles (approximate tool lifetime) for rounded edges prepared using sand blasting. During the testing, a machine feeds the steel wire between the cutting edges of the wire cutter, and each cycle corresponds to a full cut of the wire. In FIG. 13A, the cutting edge (hardness of 64 HRC and an angle of 60°) was subjected to 4500 cycles, and in FIG. 13B, the cutting edge (hardness of 64 HRC and angle of 45°) was subjected to 5000 cycles. From FIGS. 13A and 13B, it can be seen that there is no deformation on the cutting edges, and there is no evidence of brittle failure. By contrast, a cutting edge (hardness of 64 HRC and angle of 45°) was not subject to edge preparation, and the sample failed after only 124 cycles.

With respect to FIGS. 13C-13F, the estimated lifetime of different cutting edge shapes is compared. In FIG. 13C, a chamfered edge 61′ having a variable chamfer from 0.04 mm to 0.10 mm is shown. The variable chamfer edge 61′ is representative of a cutting edge of a wire stripper that is commercially available. FIG. 13D depicts an edge-prepped rounded edge 58′ having a nominal radius of curvature of 0.06 mm according to the present disclosure. In the same manner as discussed above, the cutting edges were tested for durability by repeated cutting 12 ga steel wire. As shown in FIG. 13E, the chamfered edge 61′ failed after about 1000 cycles, exhibiting an edge crack having a depth of 0.363 mm. By contrast, as shown in FIG. 13F, the edge-prepped cutting edge 58 survived 10,000 cycles with no evidence of failure (i.e., no visible chips or cracks in the edge).

In testing the two edge types shown in FIGS. 13C-13F, it was found that repeatedly reproducing the variable chamfered edge 61′ was difficult. The variable chamfer is likely formed using a solid steel cutting tool or a ream/deburr tool, and commercially available tools tested in preparing the chamfered edge 61′ display a wide range of chamfer angles and sizes, demonstrating the lack of repeatability. Advantageously, the edge-prepped rounded edge 58 can be repeatedly reproduced with a high degree of uniformity.

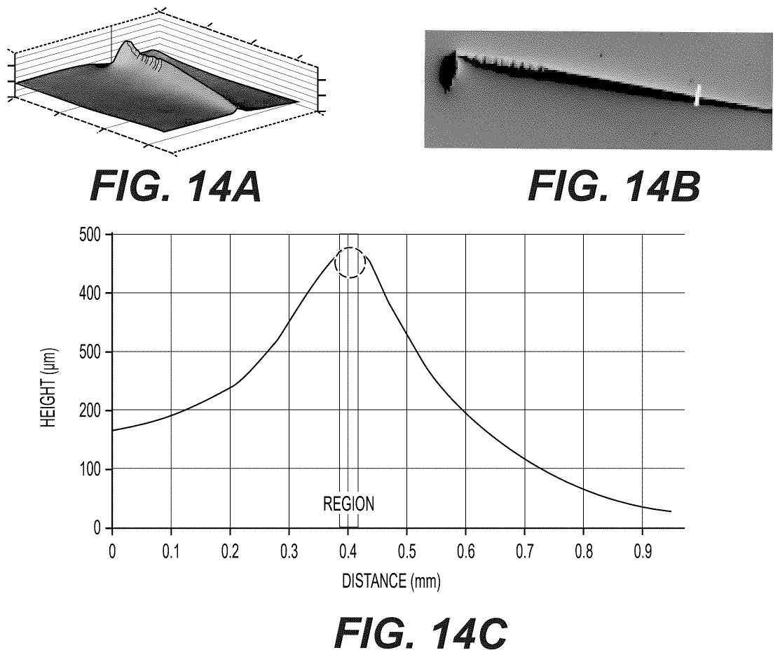

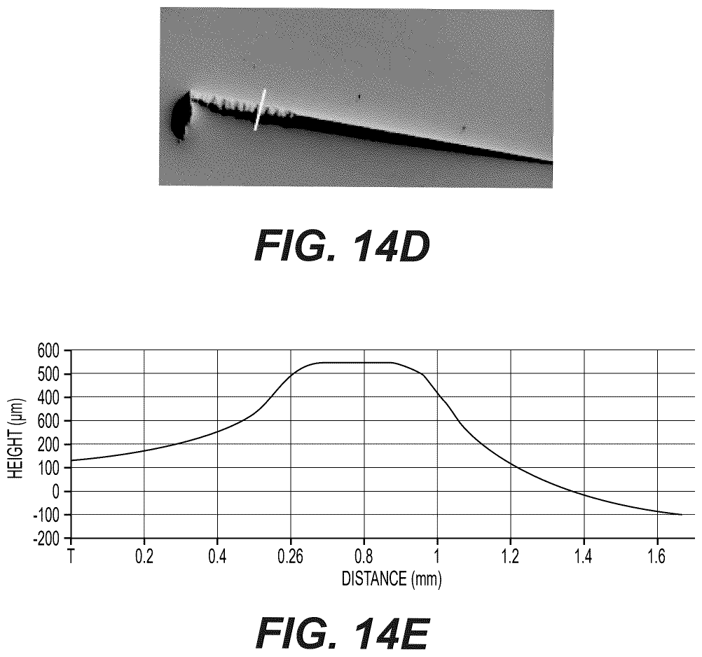

The cutting edges of the wire cutters used to cut the aircraft cable were probed for edge topography using a tactile sensor. FIGS. 14A-E depict the profile of the cutting edge in the as-ground state after the aircraft cable was cut. FIG. 14A provides a three-dimensional plot of the edge, and FIG. 14B provides an image of the cutting edge as scanned by the tactile sensor. The line extending across the cutting edge represents the position on the cutting edge where the height profile of FIG. 14C was measured. As can be seen from FIG. 14C, the peak of the height profile was fitted with a circle to determine the radius of curvature, which was determined to be 0.024 mm. FIG. 14D identifies on the scanned image where the height profile was measured across the region where the cut was made. FIG. 14E provides the height profile. As can be seen, the height profile is significantly flatter than the rest of the cutting edge, demonstrating the significant deformation to the cutting edge caused by cutting the aircraft cable. In particular, the edge is flattened over a width of 0.35 mm.

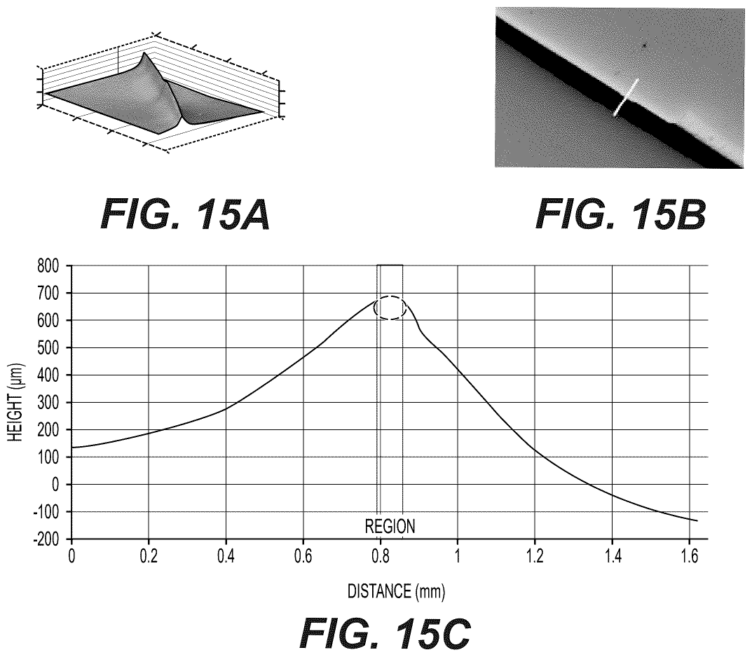

FIGS. 15A-15E depict the profile of the cutting edge for the 60° cutting edge that was edge prepped by polishing with a brush wheel, including the region where the aircraft cable was cut. FIG. 15A provides a three-dimensional plot of the cutting edge, and FIG. 15B provides an image of the cutting edge as scanned by the tactile sensor. The line extending across the cutting edge represents the position on the cutting edge where the height profile of FIG. 15C was measured. As can be seen from FIG. 15C, the peak of the height profile was fitted with a circle to determine the radius of curvature of the prepped edge, which was determined to be 0.042 mm. FIG. 15D identifies on the scanned image where the height profile was measured across the region where the cut was made. FIG. 15E provides the height profile. As can be seen in comparison to FIG. 14E, the height profile of FIG. 15E maintains much more of the original radius. For the sake of comparison, a flat region was identified as shown by the line across the peak in FIG. 15E. The flat region identified had a width of 0.204 mm, which is about 40% less than the flat region caused by cutting in the embodiment of FIG. 14E.

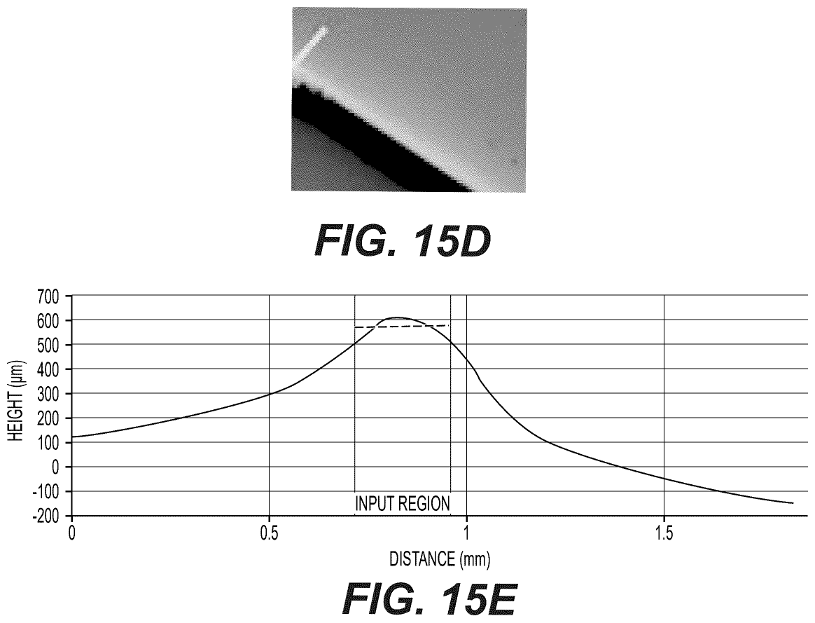

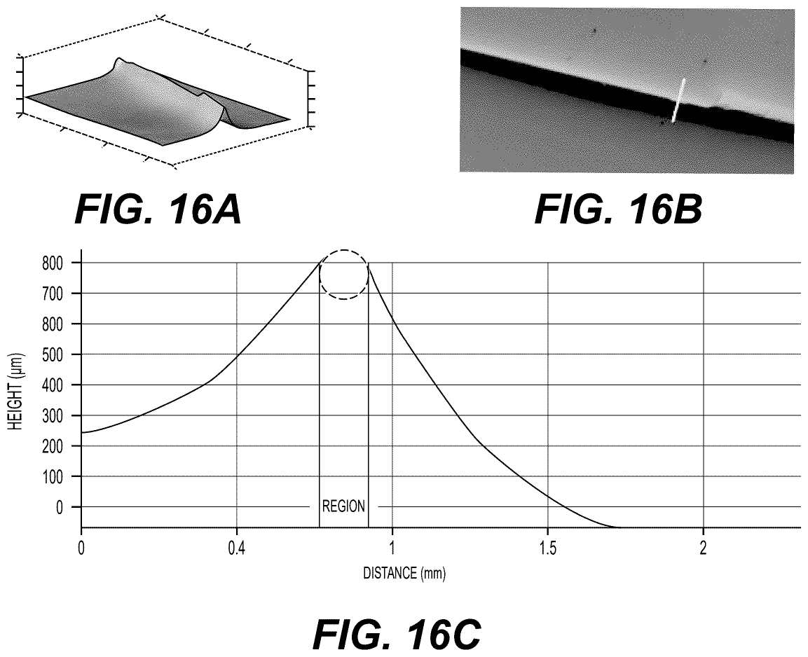

FIG. 16A-C depict the profile of the cutting edge for a 60° cutting edge that was edge prepped by sand blasting. FIG. 16A provides a three-dimensional plot of the cutting edge, and FIG. 16B provides an image of the cutting edge as scanned by the tactile sensor. The line extending across the cutting edge represents the position on the cutting edge where the height profile of FIG. 16C was measured. As can be seen from FIG. 16C, the peak of the height profile was fitted with a circle to determine the radius of curvature of the prepped edge, which was determined to be 0.077 mm.

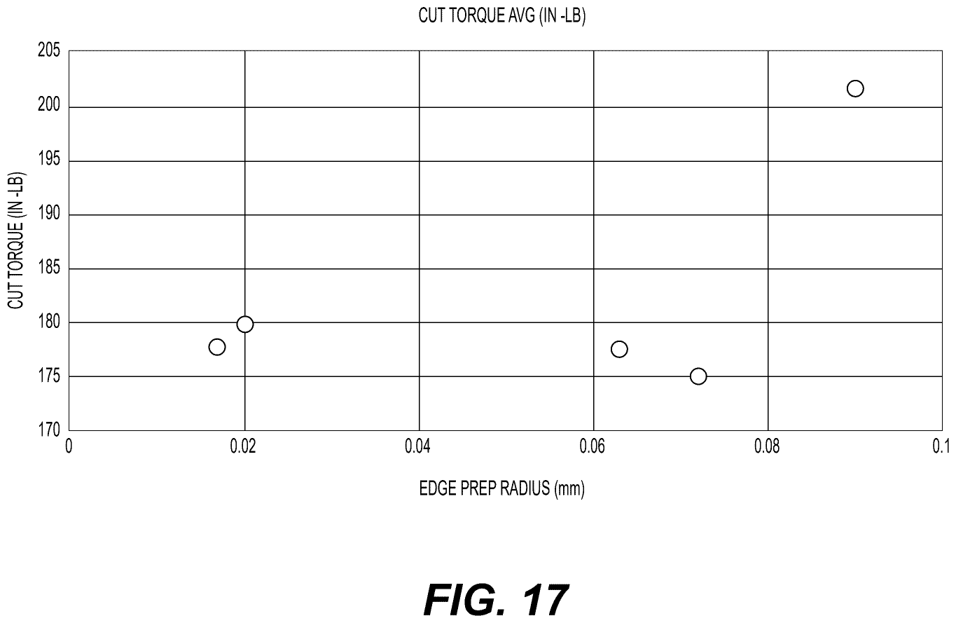

FIG. 17 provides a plot of average cutting torque based on the nominal radius of the cutting edge. In the graph, the points at or below a radius of curvature of about 0.02 mm correspond to an as-ground edge. For the rounded edge, points were tested at a nominal radius of curvature of about 0.06 mm and above. As can be seen, for the radius of curvature in the range of about 0.06 mm to about 0.085 mm, the average cutting torque is the same or less than the as-ground edge. Thus, the edge preparation does not affect, or even decreases, the average cutting torque required to make a cut using the cutting edge. However, above a radius of curvature of about 0.09 mm, the average cutting torque increases drastically from below about 180 in·lb to over 200 in·lb.

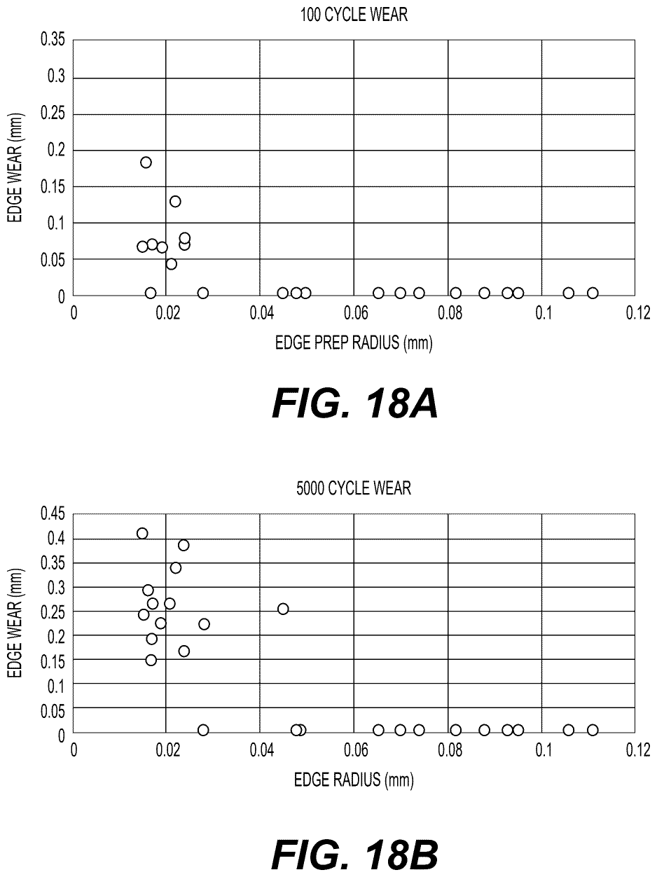

FIGS. 18A and 18B depict edge wear after 100 cutting cycles and after 5000 cutting cycles based on the nominal radius of the tested cutting edge. As can be seen in FIG. 18A, there is noticeable edge wear for the cutting edges below about 0.025 mm, whereas for radiuses above about 0.030 mm, there is substantially no measurable wear. As shown in FIG. 18B, the edge wear for cutting edges with a radius of curvature above about 0.030 mm remains substantially 0 (except for a single outlier measurement). The edge wear for cutting edges with a radius of curvature below about 0.030 mm (as-ground edge) increases substantially with increased cutting cycles.

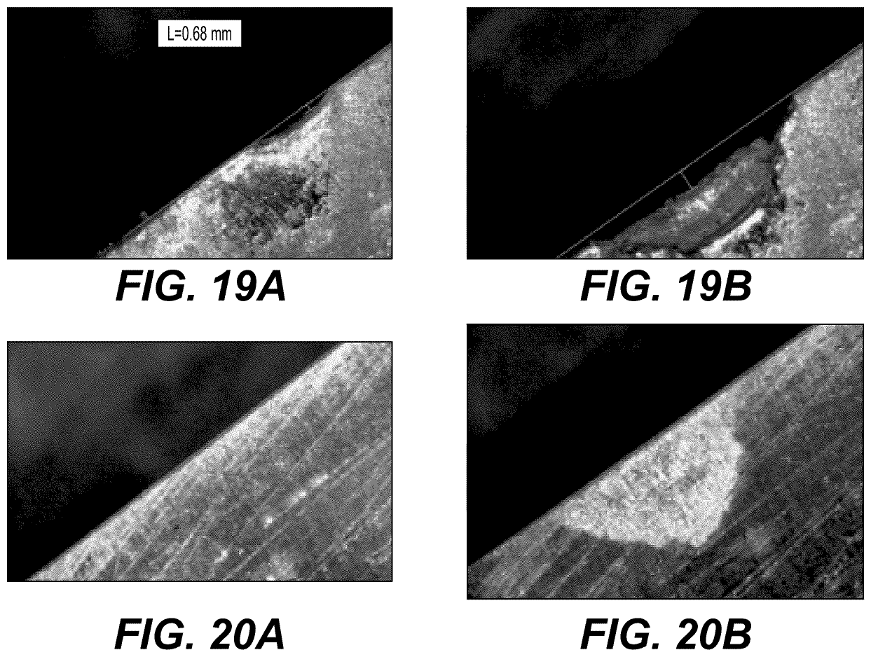

The difference in cutting edge wear for an as-ground edge and for a rounded edge is shown in FIGS. 19A-19B and 20A-20B, respectively. As shown in FIGS. 19A, the wear on an as-ground edge is shown after 100 cutting cycles, and there is significant deterioration of the cutting edge. The deterioration of the cutting edge is even greater after 5000 cutting cycles as shown in FIG. 19B. By contrast, FIGS. 20A and 20B show a rounded edge after 100 cutting cycles and 5000 cutting cycles, respectively. As expected from the plots of FIGS. 18A and 18B, the rounded edge exhibits substantially no edge wear.

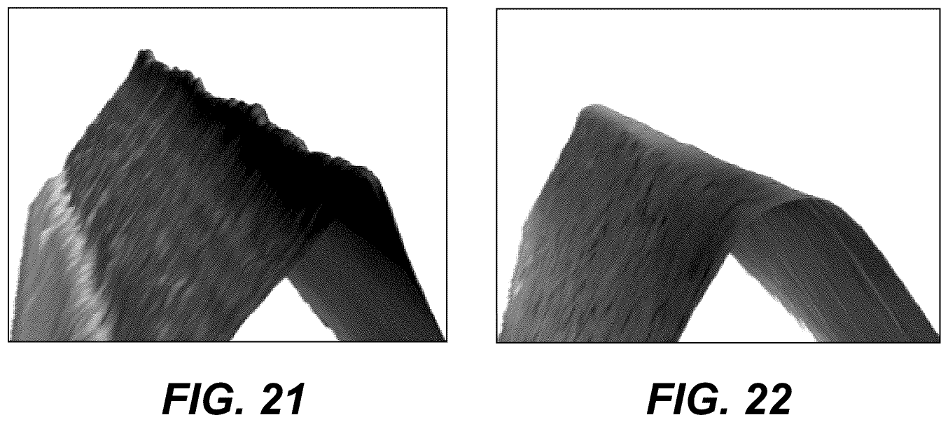

FIGS. 21 and 22 depict 3D scanner images of an as-ground cutting edge and a rounded cutting edge, respectively, as captured using an optical profilometer. The as-ground cutting edge is jagged with chips and cuts that can act as initiation points for crack propagation. By contrast, the rounded cutting edge is comparatively smooth and even without any substantial defects that could act as initiation points for crack propagation. Additionally, as can be seen in a comparison between FIGS. 21 and 22, the as-ground edge has first and second surfaces, which intersect to form the as-ground cutting edge, that are much rougher than the first and second surfaces intersecting to form the rounded cutting edge. Advantageously, the lower roughness of the surfaces improve cutting performance by decreasing interaction between the workpiece and the surfaces of the cutting edge.

It should be understood that the figures illustrate the exemplary embodiments in detail, and it should be understood that the present application is not limited to the details or methodology set forth in the description or illustrated in the figures. It should also be understood that the terminology is for description purposes only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one. As used herein, “rigidly coupled” refers to two components being coupled in a manner such that the components move together in a fixed positional relationship when acted upon by a force.

Various embodiments of the disclosure relate to any combination of any of the features, and any such combination of features may be claimed in this or future applications. Any of the features, elements or components of any of the exemplary embodiments discussed above may be utilized alone or in combination with any of the features, elements or components of any of the other embodiments discussed above.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A hand tool, comprising:
a first jaw assembly comprising a first handle portion, a first jaw portion, and a first pivot portion disposed between the first handle portion and the first jaw portion, the first jaw portion comprising a first cutting edge;
a second jaw assembly comprising a second handle portion, a second jaw portion, and a second pivot portion disposed between the second handle portion and the second jaw portion, the second jaw portion comprising a second cutting edge;
wherein the first cutting edge and the second cutting edge are configured to operate as a wire cutter;
wherein each of the first cutting edge and the second cutting edge comprises a first surface and a second surface in which the first surface is arranged at an angle in a range from 300 to 750 with respect to the second surface;
wherein each of the first cutting edge and the second cutting edge comprises a rounded edge connecting the first surface to the second surface in which a radius of curvature of the rounded edge is in a range of 0.02 mm to 0.09 mm.

2. The hand tool according to claim 1, wherein the second surfaces are in different planes such that the first cutting edge and the second cutting edge are in a bypass configuration.

3. The hand tool according to claim 1, wherein at least one of the first cutting edge or the second cutting edge comprises a ceramic coating having a resistivity of at least at least 1.0×10⁸ Ω·cm.

4. The hand tool according to claim 3, wherein the resistivity is in a range of 1.0×10⁸ Ω·cm to 1.0×10¹⁴ Ω·cm.

5. The hand tool according to claim 1, wherein the first jaw portion comprises a first plurality of aperture portions, the first cutting edge being disposed between the first plurality of aperture portions and the first pivot portion;
wherein the second jaw portion comprises a corresponding plurality of aperture portions, the second cutting edge being disposed between the corresponding plurality of aperture portions and the second pivot portion; and
wherein the first plurality of aperture portions and the corresponding plurality of aperture portions, in a closed configuration of the hand tool, define wire stripper apertures having sizes configured to remove insulating jacket material from wires of a plurality of gauges.

6. The hand tool according to claim 1, wherein the first pivot portion comprises a first cutting recess having a first edge and the second pivot portion comprises a second cutting recess having a second edge;
wherein the first edge is defined between surfaces arranged at an angle in a range of 75° to 85°; and
wherein the second edge is defined between surfaces arranged at an angle in a range of 75° to 85°.

7. The hand tool according to claim 6, wherein at least one of the first edge or the second edge comprises a radius of curvature in a range of 0.02 to 0.09 mm.

8. The hand tool according to claim 1, wherein the first jaw portion and the first pivot portion are formed separately from the first handle portion and joined to the first handle portion using a fastener;
wherein the second jaw portion and the second pivot portion are formed separately from the second handle portion and joined to the second handle portion using a fastener; and
wherein the first jaw portion and the second jaw portion each comprise a spring constant in a range from 450 N/mm to 550 N/mm.

9. The hand tool according to claim 8, wherein the first jaw portion and the second jaw portion each comprise an ultimate tensile strength in a range of 2100 MPa to 2500 MPa.

10. The hand tool according to claim 1, wherein the radius of curvature of the rounded edge is in a range of 0.03 mm to 0.08 mm.

11. The hand tool according to claim 1, wherein the first cutting edge and the second cutting edge exhibit edge wear of 0.05 mm or less after 100 cutting cycles of the wire cutting.

12. The hand tool according to claim 1, wherein the first cutting edge and the second cutting edge exhibit edge wear of 0.1 mm or less after 5000 cutting cycles of the wire cutter.

13. The hand tool according to claim 1, wherein a cutting torque required to actuate the wire cutter is 200 in·lb or less.

14. The hand tool according to claim 1, wherein, for each of the first cutting edge and the second cutting edge, the first surface is arranged at an angle in a range from 45° to 60° with respect to the second surface.

15. The hand tool according to claim 1, wherein the rounded edge of each of the first cutting edge and of the second cutting edge comprises a depth of material removal in a range of 0.045 mm to 0.095 mm;
wherein the depth of material removal corresponds to a distance from a theoretical sharp edge to the rounded edge along a line bisecting the angle between the first surface and the second surface; and
wherein the theoretical sharp edge corresponds to an intersection of a first plane extending from the first surface and a second plane extending from the second surface.

16. The hand tool according to claim 1, wherein the hand tool is one of a wire stripper, a lineman's pliers, or a diagonal pliers.

17. A hand tool, comprising:
a first jaw assembly comprising a first handle portion, a first jaw portion, and a first pivot portion disposed between the first handle portion and the first jaw portion, the first jaw portion comprising a first cutting edge;
a second jaw assembly comprising a second handle portion, a second jaw portion, and a second pivot portion disposed between the second handle portion and the second jaw portion, the second jaw portion comprises a second cutting edge;
wherein the first cutting edge and the second cutting edge are configured to operate as a wire cutter; and
wherein at least one of the first cutting edge and the second cutting edge comprises a ceramic coating having a resistivity of at least at least 1.0×10⁸ Ω·cm.

18. The hand tool according to claim 17, wherein the resistivity is in a range of 1.0×10⁸ Ω·cm to 1.0×10¹⁴ Ω·cm.

19. The hand tool according to claim 17, wherein the ceramic coating comprises a thickness is in a range from 0.01 mm to 1 mm.

20. The hand tool according to claim 17, wherein each of the first cutting edge and the second cutting edge comprise a first surface and a second surface, the first surfaces each being at an angle in a range of 300 to 750 relative to the respective second surfaces and the second surfaces being in different planes such that the first cutting edge and the second cutting edge are in a bypass configuration.

21. The hand tool according to claim 20, wherein the cutting edge comprises a radius of curvature in a range of 0.02 to 0.09 mm between each first surface and the respective second surface of the first cutting edge and of the second cutting edge.

22. A hand tool, comprising:
a first jaw assembly comprising a first handle portion, a first jaw portion, and a first pivot portion disposed between the first handle portion and the first jaw portion, the first jaw portion comprising a first cutting edge;
a second jaw assembly comprising a second handle portion, a second jaw portion, and a second pivot portion disposed between the second handle portion and the second jaw portion, the second jaw portion comprising a second cutting edge;
wherein the first cutting edge and the second cutting edge are configured to operate as a wire cutter;
wherein each of the first cutting edge and the second cutting edge comprises a first surface and a second surface in which the first surface is arranged at an angle in a range from 30° to 75° with respect to the second surface;
wherein each of the first cutting edge and the second cutting edge comprises a rounded edge connecting the first surface to the second surface;
wherein the rounded edge of each of the first cutting edge and of the second cutting edge comprises a depth of material removal in a range of 0.045 mm to 0.095 mm;
wherein the depth of material removal corresponds to a distance from a theoretical sharp edge to the rounded edge along a line bisecting the angle between the first surface and the second surface; and
wherein the theoretical sharp edge corresponds to an intersection of a first plane extending from the first surface and a second plane extending from the second surface.

23. The hand tool according to claim 22, wherein the second surfaces are in different planes such that the first cutting edge and the second cutting edge are in a bypass configuration.

24. The hand tool according to claim 22, wherein a radius of curvature of the rounded edge is in a range of 0.02 mm to 0.09 mm.

25. The hand tool according to claim 24, wherein the radius of curvature of the rounded edge is in a range of 0.03 mm to 0.08 mm.

26. The hand tool according to claim 22, wherein the first cutting edge and the second cutting edge exhibit edge wear of 0.05 mm or less after 100 cutting cycles of the wire cutting.

27. The hand tool according to claim 22, wherein the first cutting edge and the second cutting edge exhibit edge wear of 0.1 mm or less after 5000 cutting cycles of the wire cutter.

28. The hand tool according to claim 22, wherein a cutting torque required to actuate the wire cutter is 200 in·lb or less.

29. The hand tool according to claim 22, wherein, for each of the first cutting edge and the second cutting edge, the first surface is arranged at an angle in a range from 45° to 60° with respect to the second surface.

30. The hand tool according to claim 22, wherein the hand tool is one of a wire stripper, a lineman's pliers, or a diagonal pliers.
